(19) United States
(12) Patent Application Publication
(10) Pub. No.: US 2009/0198562 A1
(43) Pub. Date: Aug. 6, 2009

(54) GENERATING SOCIAL GRAPH USING MARKET DATA

(76) Inventors: Guenter Wiesinger, Landau (DE); Thomas Seifert, Berlin (DE); Nicklas Weich, Berlin (DE)

Correspondence Address: SCHWEGMAN, LUNDBERG & WOESSNER/EBAY, P.O. BOX 2938, MINNEAPOLIS, MN, 55402, US

(21) Appl. No.: 12/324,393

(22) Filed: Nov. 26, 2008

Related U.S. Application Data
(60) Provisional application No. 61/024,964, filed on Jan. 31, 2008.

(51) Int. Cl. G06Q 10/00; G06T 11/20

(52) U.S. Cl. 705/10; 345/441

(57) ABSTRACT

A social graph may be generated using a system and method to: identify a focal user, the focal user associated with a transaction; determine a related user associated with the transaction, the related user having a buyer-seller relationship with the focal user; and present the focal user and the related user using a multi-node graph, the multi-node graph including a first node and a second node representing the focal user and the related user, respectively, and a first connector representing the buyer-seller relationship linking the first and second nodes, the first connector being presented with meta-data describing a characteristic of the buyer-seller relationship. Additional apparatus, systems, and methods are disclosed.

### RELATED PATENT DOCUMENTS

This patent application claims the benefit of priority, under 35 U.S.C. Section 119(e), to U.S. Provisional Patent Application Ser. No. 61/024,964, entitled “GENERATING SOCIAL GRAPH USING MARKET DATA,” filed on Jan. 21, 2008, the contents of which are hereby incorporated by reference in its entirety.

### BACKGROUND

A social graph consists of nodes that represent people or groups with whom an individual is connected based on connections, such as work, friendship, interests, and location.

### BRIEF DESCRIPTION OF THE DRAWINGS

Some embodiments are illustrated by way of example and not limitation in the figures of the accompanying drawings in which:

FIG. 1 is a schematic diagram illustrating a network system having a client-server architecture, according to an example embodiment;

FIG. 2 is a block diagram illustrating multiple marketplace applications that, in an example embodiment, are provided as part of a network-based marketplace;

FIG. 3 is a data flow diagram of a network system, according to an example embodiment;

FIG. 4 is a block diagram illustrating portions of a system to process data and present social graphs, according to an example embodiment;

FIG. 5 is a flow chart illustrating a method to process data and present social graphs, according to an example embodiment;

FIGS. 6-8 are diagrams illustrating a variety of graphical user interfaces (GUIs), according to example embodiments; and

FIG. 9 is a block diagram of a machine in the form of a computer system within which a set of instructions for causing the machine to perform any one or more of the methodologies discussed herein may be executed, according to an example embodiment.

### DETAILED DESCRIPTION

Example methods, apparatus, and systems to generate social graphs will be described. In the following description, for purposes of explanation, numerous specific details are set forth in order to provide a thorough understanding of example embodiments. It will be evident, however, to one skilled in the art that the various embodiments may be practiced without these specific details. For example, while the apparatus, systems, and methods described herein are directed to representing relationships in an online marketplace, these mechanisms can be applied to any number of other online systems, such as communication systems, reputation systems, and relationship systems.

As an illustrative example, in an online marketplace, buyers and sellers interact to buy and sell goods or services. Each transaction may be represented using a connector (i.e., edge) in a social graph, where the buyer and seller are each represented using a node in the graph. Elements and aspects of the transaction may be represented using the connector by varying the weight, color, fill pattern, or by using a directed line (e.g., one or two arrowheads), for example. Similarly, one or more characteristics of the buyer and seller may be represented using the nodes, such as by varying the size, shape, color, fill pattern, or other graphical elements associated with or contained within the node. By using the node and/or the connector in this manner, meta-information or meta-data may be represented as inherent properties. For example, a heavier connector line may indicate a stronger relationship between the nodes it connects. As another example, a node with a particular fill color or pattern may be used to indicate a reliable buyer or seller. Other types of representations will become apparent in the following description.

While this description discusses social graphs in the context of an online marketplace, it is understood that the description is not limited to such an implementation. For example, in a telecommunications context, each node may represent a cellular telephone customer and each edge may represent a telephone call made between users. As another example, in an enterprise messaging system (e.g., email), nodes may represent email addresses and edges may represent messages sent from one email address to another email address.

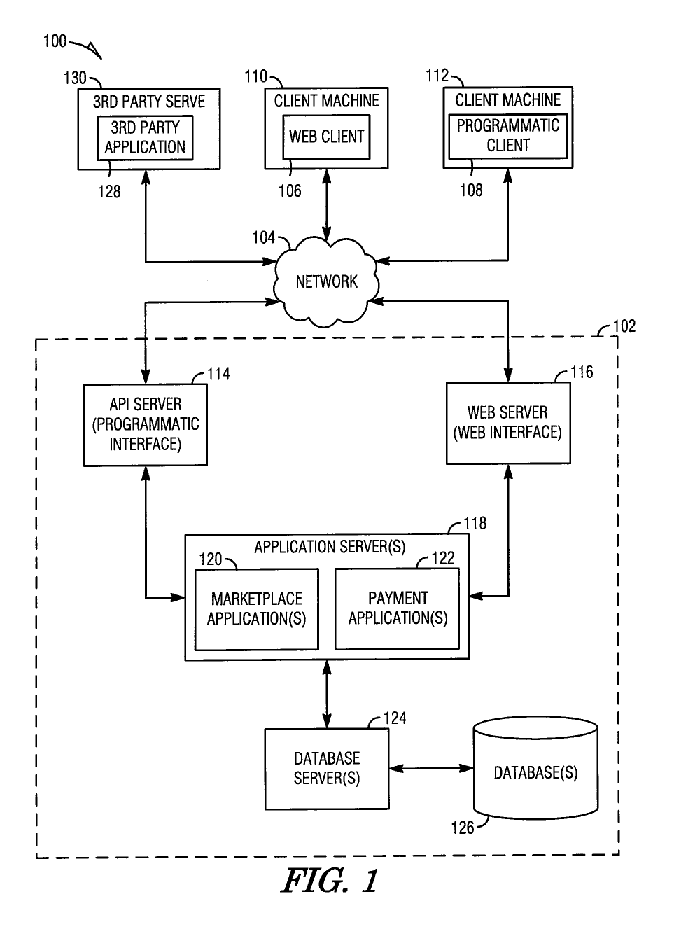

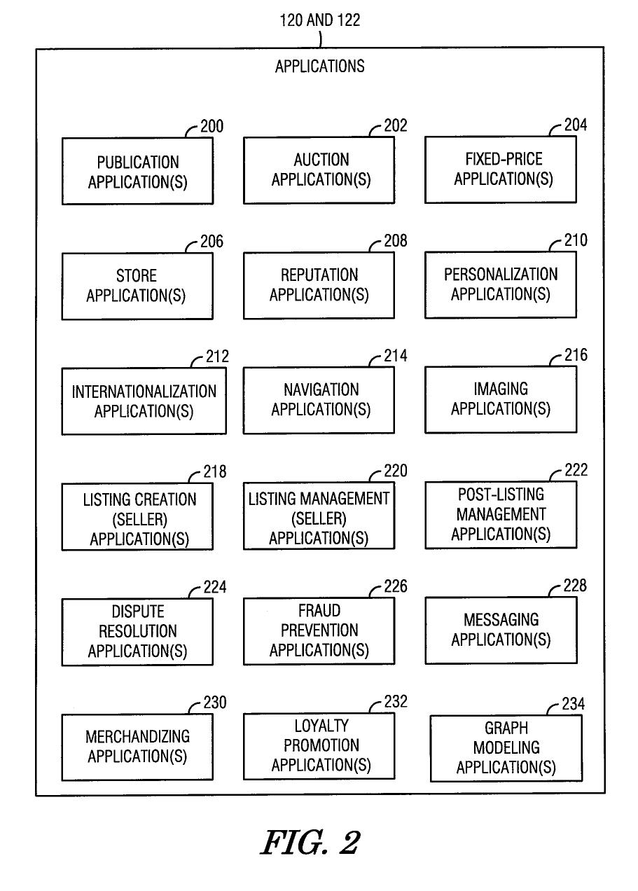

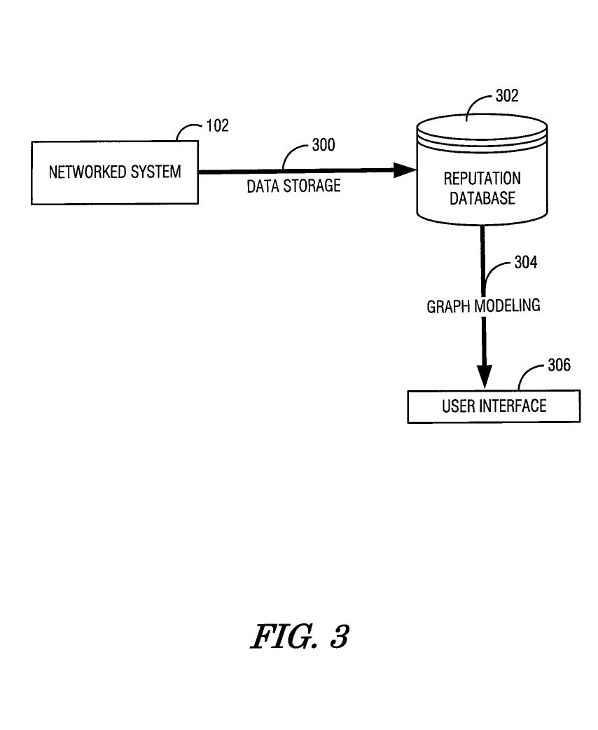

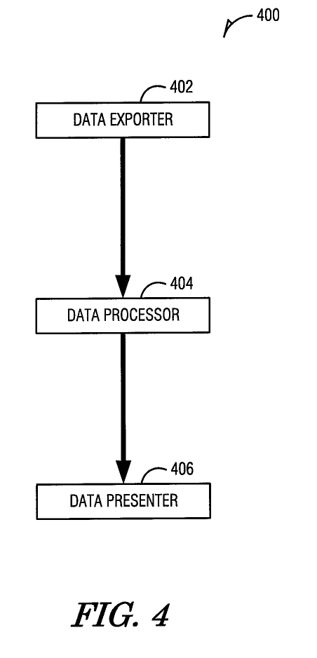

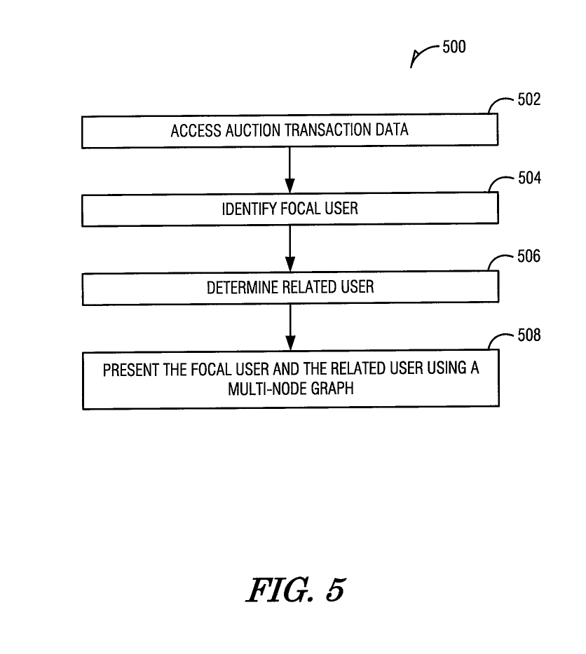

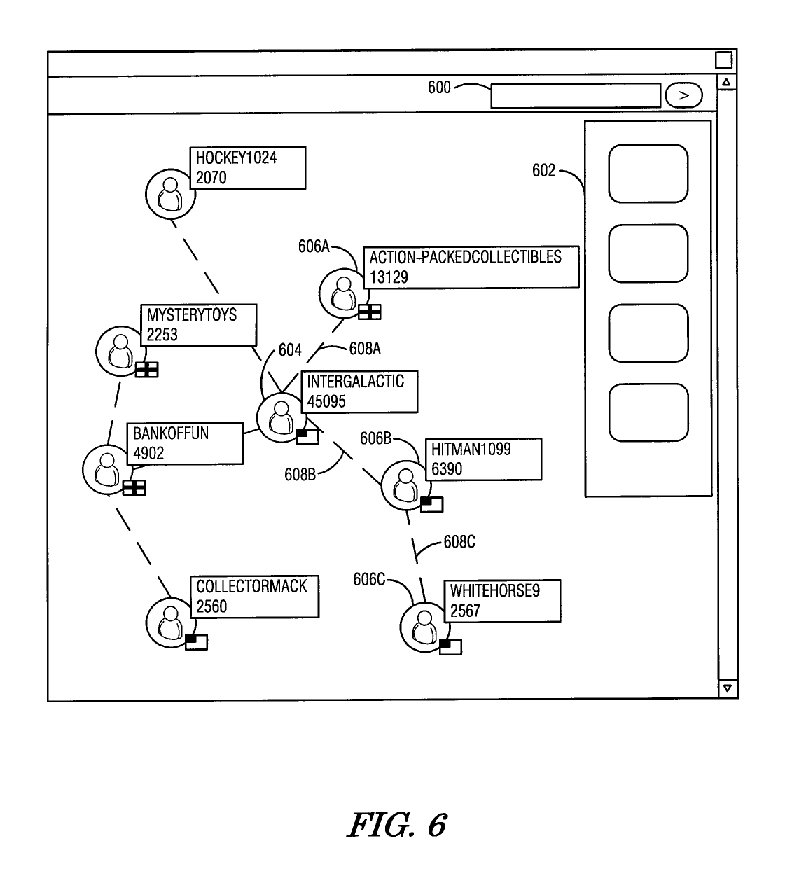

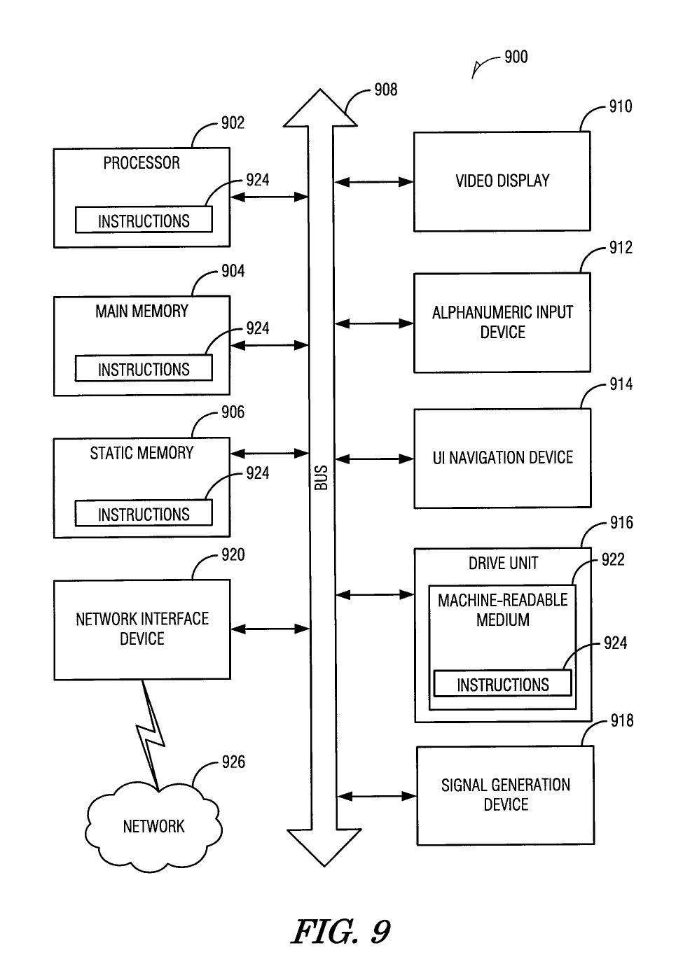

The following sections include a description of a platform for generating social graphs (FIG. 1), marketplace and payment applications (FIG. 2), data flow for graph generation (FIG. 3), a system for performing the data flow (FIG. 4), flowcharts of methods for generating social graphs (FIG. 5), user interface diagrams (FIGS. 6-8), and a machine diagram (FIG. 9).

### Platform Architecture

FIG. 1 is a schematic diagram illustrating a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer® browser developed by Microsoft Corporation of Redmond, Wash.) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, coupled to one or more database servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the various embodiments are not limited to such an architecture, perhaps finding application in a distributed, or peer-to-peer, architecture system, for example. The various marketplace and payment applications 120, 122 could also be implemented as standalone software programs, which do not necessarily have networking capabilities.

The web client 106 accesses the various marketplace and payment applications 120, 122 via the web interface supported by the web server 116. Similarly, the programmatic client 108 accesses the various services and functions provided by the marketplace and payment applications 120, 122 via the programmatic interface provided by the API server 114. The programmatic client 108 may, for example, comprise a seller application (e.g., the TurboLister application developed by eBay Inc., of San Jose, Calif.) to enable sellers to author and manage listings on the networked system 102 in an off-line manner and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

### Marketplace Applications

FIG. 2 is a block diagram illustrating multiple marketplace and payment applications 120, 122 that, in an example embodiment, are provided as part of the networked system 102. The applications 120, 122 may be hosted on dedicated or shared server machines (not shown) that are communicatively coupled to enable communications between the machines. The applications 120, 122 themselves are communicatively coupled (e.g., via appropriate interfaces) to each other and to various data sources, so as to allow information to be passed between the applications or so as to allow the applications to share and access common data. The applications 120, 122 may furthermore access one or more databases 126 via the database servers 124.

Referring now to FIGS. 1 and 2, it can be seen that the networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature, whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and may allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example through feedback provided by other transaction partners) to establish a reputation over time within the networked system 102. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized (for example, for specific geographic regions). A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings available via the networked system 102 visually informing and attractive the marketplace applications 120 may include one or more imaging applications 216. Users may utilize the one or more imaging applications 216 to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to offer for sale via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102. Such messages may, for example, advise users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via wired (e.g., the Internet), Plain Old Telephone Service (POTS), or wireless (e.g., mobile, cellular, WiFi, WiMAX) networks.

Merchandising applications 230 support various merchandising functions that are made available to sellers, thereby enabling sellers to increase sales via the networked system 102. The merchandising applications 230 also operate the various merchandising features that may be invoked by sellers and may monitor and track the success of merchandising strategies employed by sellers.

The networked system 102 itself, or one or more parties that engage in transactions via the networked system 102, may operate loyalty programs that are supported by one or more loyalty/promotions applications 232. For example, a buyer may earn loyalty or promotions points for each transaction established and/or concluded with a particular seller and may be offered a reward for which accumulated loyalty points can be redeemed.

Graph modeling applications 234 support various data manipulation and organization processes. In an embodiment, relationships between users of the networked system 102 may be represented using a graph. Graph modeling applications 234 may include applications that are operable to access and obtain data, organize and store the data, and graphically represent the data in various forms. As an example, by analyzing past transactions, a network of users may be represented where each user is a node in the network and each transaction between users is an edge connecting the respective nodes. The graph modeling applications 234 may also include decisional components. The decisional components may operate to filter, combine, or otherwise manipulate the underlying data so that output graphs are easier to interpret or more useful to the viewer.

In various embodiments, the graph modeling applications 234 interface with other applications in the networked system 102, such as the reputation applications 208, personalization applications 210, imaging applications 216, or messaging applications 228. These interfaces are described in more detail below.

### Data Flow

FIG. 3 is a data flow diagram illustrating data and control flow within a network system. Auctions are conducted at the networked system 102. Auctions may include listings related to automobiles, collectibles, new items, used items, or other types of services or merchandise. In an embodiment, a reputation system is used to collect and maintain the reputations of users of the networked system 102. For example, after a sale of an item has been completed, the buyer, the seller, or both parties, may leave feedback for one another. The feedback may be in the form of a positive, negative, or neutral rating. Feedback may also include comments that further describe the transaction or aspects of the transaction. Feedback may also include other ratings or indicia on specific aspects of the transaction, such as buyer-seller communication, shipping performance, payment performance, listing accuracy, or the like.

At 300, data is stored in a reputation database 302. The data storage operation 300 may include sub-operations, such as checks for data consistency, data formatting or conditioning, and data normalization (e.g., removing outlier data points). Data storage may be performed at regular or periodic intervals, or on-demand, in various embodiments. Data storage may also be performed at real time. Real time updates may be advantageous to provide the feedback or reputation scores to other users of the networked system 102. The reputation database 302 may be a part of the networked system, in an embodiment. In another embodiment, the reputation database 302 is maintained by a separate system from the networked system 102.

In an embodiment, the reputation database 302 may be configured to store data related to transactions completed in the networked system 102. The data may include a user's total reputation score, a user's positive feedback score (the number of positive ratings left by a transacting user), a user's negative feedback score (the number of negative ratings left by a transacting user), and the like. The reputation database 302 may also be configured to store auction-related information, such as a start date and time, an end date and time, a starting price, a final price, a reserve price, a number of bids, a number of bidders, financing terms, a seller, or a buyer.

Using the data stored in the reputation database 302, a graph modeling operation 304 is conducted to process data and present social graphs representing data included in the reputation database 302. The graph modeling operation 304 may perform various operations, such as aggregating or organizing data for a focal user, arranging users in a logical manner around a focal user, filtering or separating transactions or users, or the like. The graph modeling operation 304 may be controlled or configured in part by a viewing user's preferences. For example, a viewing user may prefer to only view a graph that represents transactions that have occurred in the previous thirty days. This type of filtering may be performed by the graph modeling operation 304.

The user interface 306 need not be limited to an electronic medium. In various embodiments, the user interface 306 includes a printed publication, an Internet-based application (e.g., a website, a phone-based application (e.g., a toll-free number), or a mobile-based solution (e.g., SMS messaging, mobile web access). In an embodiment, the user interface 306 may be configured to provide more then one method of accessing the available information.

FIG. 4 is a schematic diagram illustrating portions of a system 400 to process data and present social graphs to the data flow illustrated in FIG. 3, according to an example embodiment. A data exporter 402 exports auction transaction data. The data exporter may include, be a component of, or be equivalent to the networked system 102, as illustrated in FIG. 3, in various embodiments. A data processor 404 processes the auction transaction data. Various statistical, mathematical, arithmetical, or organizational data manipulation may be performed by the data processor 404. Some examples of such operations are described above with reference to the graph modeling operation 304. For example, the data processor 404 may filter, condition, aggregate, or model the auction transaction data, in various embodiments. A data presenter 406 accesses the data processed by the data processor 404 and presents it to a user. The data presenter 406 may include, be a component of, or be equivalent to the user interface 306, in various embodiments.

### Methods

FIG. 5 is a flow chart illustrating a method 500 to process data and present social graphs, according to an example embodiment. At 502, auction transaction data is accessed. The auction transaction data may include feedback information, listing information, auction closing price, transaction costs, and other information related to in-progress, closed, completed, or abandoned auctions. The data records may be stored in various formats, such as a relational database, an object oriented database, a flat file database, a spreadsheet, a comma delimited value file, a structured file (e.g., an extensible markup language (XML) file), or other storage formats.

At 504, a focal user is identified using the auction transaction data. The focal user may be submitted or provided by a viewing user. For example, a viewing user may wish to determine a particular user's feedback rating and view past transactions with other users. The viewing user may then choose the particular user, for example, by clicking on a hyperlink, selecting a node in a previously-generated social graph, or selecting an identity from a search result.

At 506, a related user is determined. The related user is related to the focal user, in an embodiment, by having previously completed a transaction in the networked system 102 with the focal user (e.g., a buyer or a seller in an auction transaction). In some cases, an active buyer or seller may have a large number of transactions. When this occurs, related users may be too numerous to effectively present in a social graph. In an embodiment, determining a related user also involves processing. Such processing may include several actions, such as filtering, conditioning, aggregating, and modeling. In an embodiment, the filtering process may be configured to remove less relevant data points, such as those data points representing transactions that happened farther in the past. In an embodiment, the filtering process may be configured to selectively retain or exclude data based on an auction characteristic. For example, a database may be designed for a particular geographic region (e.g., a country or state), such that the filtering process is configured to retain data for auctions that were conducted with a seller and/or buyer in the particular geographic region. In an embodiment, the filtering process may be configured to selectively retain or exclude data based on an auction characteristic. For example, a viewing user may be more interested in viewing transaction data related to a particular type of merchandise similar to the type that the viewing user is considering purchasing from the focal user. As a result, the viewing user is presented a more relevant social graph showing transactions completed with the potential seller with respect to the same type of goods. Other types of filtering or data conditioning are described below.

The filtering process may be configurable by the viewing user or by an administrator, or by both. For example, a threshold may be configured to control the number of related users displayed for a focal user. The threshold may indicate a maximum or minimum number, or both in some cases. For example, using a minimum number, first degree related users with less than a minimal number of second degree relationships may be omitted from a social graph so that the viewing user is presented the focal user and more substantial related users. This may increase the statistical relevance of the displayed social graph (e.g., the users with a higher number of second, and even third degree relationships, may represent a more statistically sound cross-section of users in a system).

As another example, using a maximum number of users simply reduces the amount of data presented in the social graph to increase efficient viewing. Determining which related users to display may involve intelligent or adaptive routines. For example, when a focal user has 10,000 relationships with distinct related users, and where the maximum number to display is configured to be twenty-five, one intelligent routine may be to only show the twenty-five most recent transactions. Another intelligent routine may be to display the most recent twenty-five transactions with a statistically significant monetary amount involved, such as over twenty dollars. The amount may be configurable by the viewing user or an administrative user. Another intelligent routine may be to display the most recent twenty-five transactions with related users that have a statistically-significant feedback rating, such as over fifty. The intelligent or adaptive routines may be designed to present more relevant subsets of data.

An example of an adaptive routine may be one that detects the number of pixels available in a display area (e.g., a window) and reconfigures the maximum number of displayed related users based on the display space available.

A conditioning process may be used to check for data consistency and format data so as to present with a consistent usage.

In an embodiment, aggregation may include combining auction transaction data. For example, similar or related auction transaction data may be aggregated before graph modeling is performed. For example, if more than one transaction has occurred between a focal user and a related user, an edge connecting the nodes that represent each user may be presented with a heavier line, a different fill pattern, or as a different color.

At 508, the focal user and the related user are presented using a graph. The graph includes at least two nodes and at least one connector linking at least two nodes. The connector, which may be referred to as an edge, represents a buyer-seller relationship in an example embodiment. In addition, the connector may be presented with meta-data describing a characteristic of the buyer-seller relationship, in a further example embodiment. The meta-data may include a representation of a total monetary value of transactions associated with the buyer-seller relationship, an auction listing associated with the buyer-seller relationship, an item listing associated with the buyer-seller relationship, a date associated with the buyer-seller relationship, a date range associated with the buyer-seller relationship, or transaction data associated with the buyer-seller relationship.

In an example embodiment, the connector may be presented using a metric based on the buyer-seller relationship and the connector, or a characteristic of the connector, may be adjusted to represent a corresponding value of the metric. The metric may represent a number of sales, a number of transactions, a reputation score, a positive rating, or a negative rating. Adjusting the connector may take several forms, such as altering a width of the connector, altering a weight of the connector, altering a color of the connector, altering a fill pattern of the connector, including an arrowhead of the connector, excluding an arrowhead of the connector, or altering an arrowhead of the connector, in various embodiments. Such alterations may be used in combination with one another to provide additional adjustable characteristics to represent aspects of the buyer-seller relationship.

The graph may be delivered using electronic presentation (e.g., a webpage, an email, mobile web, compact disc read only memory (CD-ROM)), physical presentation (e.g., a magazine, newsletter, book, pamphlet, or flyer), or other graphical media. The graph may be configured or programmed to allow the viewing user to interact with the graph. For example, the viewing user may be able to refocus (e.g., choose a new focal user), zoom in or out to see more detail of a particular section of the graph or to see a wider view of the complete graph, pan or scroll to move portions of the graph into view, or use other user interface commands or controls to otherwise change the view, perspective, or content of the graph.

In some cases, the viewing user may be a part of the social network displayed in the graph, such that the viewing user is a related user (at some degree of separation) of the focal user. The system 400 may be configured to determine whether the viewing user is part of the social network related to the focal user. When the viewing user is found to be part of the social network related to the focal user, the relationship between the viewing user and the focal user may be presented using various means. In an embodiment, the degrees of separation between the focal user and the viewing user (related user) may be presented. For example, a label may be displayed stating “You are 4 degrees away from David,” where “David” is the focal user in this example. In another embodiment, users who represent intervening relationships may be presented in a path from the viewing user to the focal user. For example, a label may be displayed stating “You are related to Abby, who is related to Bob, who is related to Charles, who is related to David.” As another example, the nodes or edges along the path may be presented using a style or graphic to highlight the relationship between the focal user and the viewing user. As yet another example, the node or edges that make up the relationship between the focal user and the viewing user may be presented in a separate sub-graph. The sub-graph may be displayed in a child window, an overlay window, a popup window, or other similar user interface construction.

When the viewing user is the focal user, the terminology used in labels or other informational displays may be adapted appropriately. For example, when the viewing user activates a particular node in the graph, a label may be provided stating “David is 4 degrees away from you.”

In an example embodiment, the nodes in the social graph may be presenting using a geometric shape, such as a circle, a square, a triangle, an octagon, an oval, and/or a star. The use of a particular shape may reflect a characteristic of the user represented by the node. In an example embodiment, the geometric shape includes a border, with the border including a width, color, or pattern used to indicate a characteristic of the node representing the user. In another example embodiment, the geometric shape includes an interior area, the interior area including a color, an image, or a pattern used to indicate a characteristic of the node representing the user.

In an embodiment, the nodes representing related users are arranged to indicate a geographical relationship. The geographical relationship may exist with respect to nodes representing related users or with respect to the focal user and a related user, or other configurations. For example, a focal user may be located in France. In this case, related users located in China may be arranged to the right of the focal user, whereas related users located in Italy may be arranged toward the bottom of the focal user.

In an embodiment, the nodes representing related users are arranged to indicate a geographical location. In such an embodiment, a background image of a world map, or a regional map, may be used. Instead of giving an approximate coordinate or cardinal direction relative to the focal user, the related user nodes may be positioned on a map to more specifically indicate the related users' geographical locations.

In an example embodiment, an auxiliary graphical element is presented in associated with the node representing the user. In various embodiments, the auxiliary graphical element may comprise a flag to indicate a nationality of the user, a colored star to indicate a feedback rating of the user, or a miniature photograph to depict the user's identification.

### User Interfaces

FIGS. 6-8 are diagrams illustrating a variety of GUIs, according to example embodiments.

FIG. 6 illustrates a search control 600, an informational sidebar 602, a focal user 604, and a plurality of related users 606A, 606B, 606C, where each related user is connected by an edge 608A, 608B, 608C, respectively. In general, a viewing user may provide a search string via the search control 600. A search result may be provided to the viewing user, where the viewing user may then select a user to act as the focal user in the social graph. Other methods of selecting a focal user may be provided. For example, while viewing an auction listing including a seller, the viewing user may select the seller as a focal user by activating a hyperlink associated with the auction listing. The hyperlink, or other user interface control, may then initiate the generation of a social graph with the seller as the initial focal user.

In the example illustrated, the social graph includes related users that are one degree from the focal user 604 (e.g., related user 606A and 606B) and other users that are two degrees away from the focal user 604 (e.g., related user 606C) as well as users that are farther away from the focal user 604. The number of degrees of separation displayed may be configured, for example, by the viewing user or an administrative user.

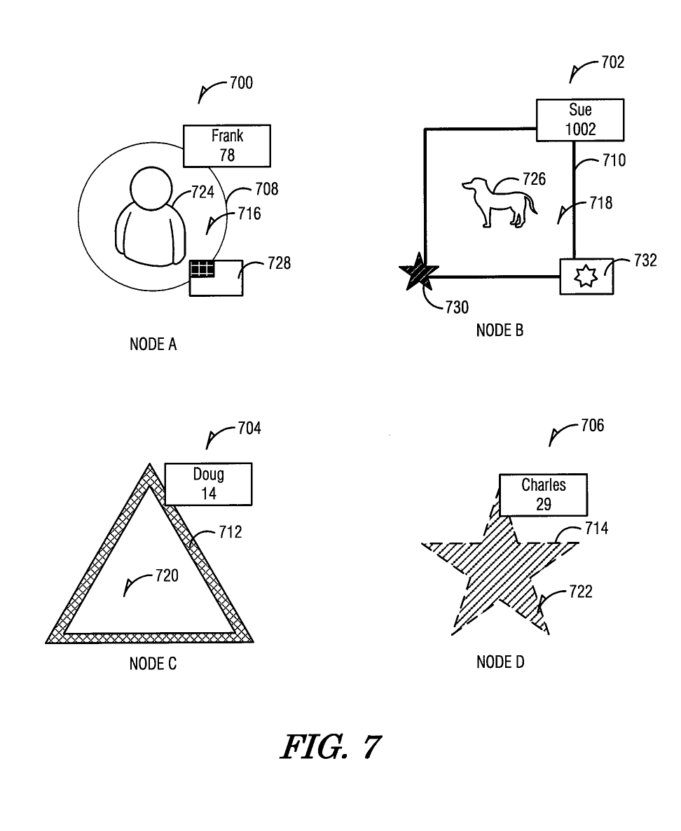

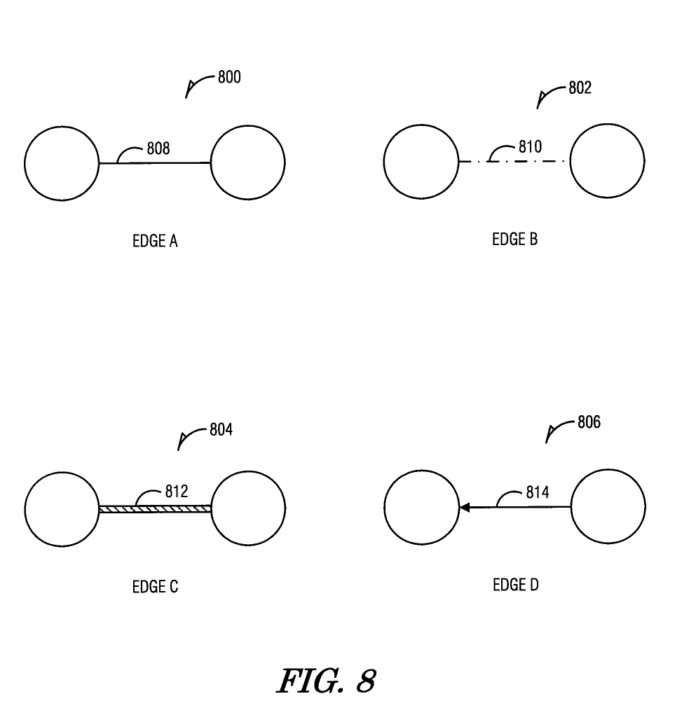

The focal user 604 and other related users 606A, 606B, 606C are connected using edges 608A, 608B, 608C (collectively referred to as 608). The edges 608 may be used to convey meta-information or meta-data. For example, while an edge 608 may be used to inherently show a connection between two nodes, the edge 608 may also be presented with characteristics that provide meta-information or meta-data about the connection itself. Examples of such characteristics and their presentation are included in FIG. 8 and are described below. Similarly, nodes may include meta-data or meta-information. Examples of node characteristics and their presentation are included in FIG. 7 and are described below.

The example illustrated in FIG. 6 also includes an informational sidebar 602. In an example embodiment, the informational sidebar 602 includes items that the current focal user 604 is presently selling. In other embodiments, the informational sidebar 602 may be used to display feedback comments, items sold, items purchased, or other information associated with the focal user 604.

FIG. 7 illustrates examples of nodes that may be included in a social graph, according to example embodiments. In general, the nodes may be classified using their shape, border, interior area, and other auxiliary graphics. For example, a node may be presented with a shape that corresponds with a characteristic of the user the node represents. The shape may be selected from the group of shapes including a circle, a square, a triangle, an octagon, an oval, or a star, in various embodiments. The particular shape used for a particular user may be based on a type of user, a reputation score, an age of a user's account, a physical location of a user, a demographic metric of the user (e.g., age, gender, height, weight, marital status, etc.) or other characteristics of the user represented by the node. In addition, a node's shape may be based on combinations of such characteristics. In the examples shown in FIG. 7, Node A 700 includes a circular shape, while Node B 702 includes a square shape. Other nodes include a triangular shape (Node C 704) and a star shape (Node D 706).

In addition, each node in the social graph may include a border. The border may vary based on a characteristic of the user represented by the node. For example, the border may vary by width, color, line pattern, or fill pattern, in various embodiments. In the examples shown in FIG. 7, Node A includes a standard-sized border 708, while Node B includes a heavier border 710, which may indicate a more or less reputable buyer or seller, for example. Further examples include Node C 704, which includes a border 712 with a fill pattern, and Node D 706, which includes a dashed border 714.

In addition, each node in the social graph may include an interior area. The interior area may be modified to vary by color, image, or fill pattern to indicate a characteristic of the user represented by the node. In the examples shown, Node A 700 includes an interior area 716 with a default image 724, Node B 702 includes an interior area 718 with a user-selected image 726, Node C 704 includes an interior area 720 with a default color (white), and Node D 706 includes an interior area 722 with a filled pattern.

In addition, each node in the social graph may include one or more auxiliary graphics. The auxiliary graphics may be positioned in close relationship with the node, for example, overlaying a portion of the node, appearing “under” or “behind” the node, or positioned in close proximity to clearly convey the node and the auxiliary graphic's relationship to one another. In various embodiments, the auxiliary graphic may include a flag to indicate a nationality of the user, a colored star to indicate a feedback rating of the user, or a miniature photograph or icon to depict the user's identification. In the examples shown in FIG. 7, Node A 700 includes an auxiliary graphic 728 in the form of a flag. The flag may be used to indicate a user's nationality or region of registration, for example. Node B 702 includes an auxiliary graphic 730 of a colored star, which may be used to indicate a feedback rating or a reputation score, and a second auxiliary graphic 732 of a flag, which may be used to indicate similar information as auxiliary graphic 728.

In addition, each node includes a label used to identify the user associated represented by the node. The label may also include other information, such as the feedback rating of the user, the user's nationality, the user's account age, or other aspects of the user's account, account activity, purchase history, selling history, or the like.

FIG. 8 illustrates examples of connectors (edges) that may be included in a social graph, according to example embodiments. Although the edges are illustrated using circular nodes, it is understood that any representation of nodes may be used, as described above. Edge A 800 is represented with a solid line 808. The solid line 808 may be presented with different widths or weights to indicate a characteristic of the relationship between the nodes. For example, a stronger relationship between the nodes (e.g., more transactions conducted or a higher total worth of transactions) may be represented with a wider or heavier line.

In FIG. 8, Edge B 802 is represented with a dashed line 810. The dashed line 810 may use varying patterns or widths (weight) to indicate a characteristic of the relationship between the nodes. For example, the dashed line 810 may be used to indicate a currency or recency of the transaction between people represented by the two nodes (e.g., a less recent transaction may be represented using a grayscale dashed line and a more recent transaction may be represented with a solid bold line). As a transaction ages, the dashed line used to represent the relationship may change (e.g., to be spaced farther apart or include more dots), until the transaction is so old that the relationship is no longer represented with an edge and the associated node on the distal end of the relationship may not be displayed. Dashed lines or other connector characteristics may also be used to indicate other characteristics, such as aborted or failed transactions, or transactions that were reversed or nullified.

In FIG. 8, Edge C 804 is represented using a line 812 with a fill pattern. The fill pattern may vary based on characteristics of the relationship between the nodes. For example, the fill pattern may be used similar to that of the dashed line to indicate a currency of a transaction. As a transaction ages, the fill pattern may change, until the fill is completely transparent, indicating that the transaction is over some threshold age. As another example, the fill pattern may be used to indicate the type of transaction, such as a successful transaction, failed transaction, aborted transaction, mutually nullified transaction, or other types of transaction status. As another example, a fill pattern may be used to indicate a type of goods or services exchanged (e.g., automobile, collectible, clothing, electronics, etc.), a type of payment method used (e.g., instant payment, credit card, check, etc.), a type of auction conducted (e.g., buy-it-now, standard auction, Dutch auction, etc.), or other aspects of the transaction.

In FIG. 8, Edge D 806 is represented with a directed line 814. The directed line may include one or two arrowheads, indicating a unidirectional or bidirectional relationship, respectively. In addition, the arrowheads may be different to indicate a particular characteristic of the directional relationship. For example, a solid arrowhead may indicate a favorable transaction, whereas a hollow arrowhead may indicate an unfavorable transaction (e.g., non-payment or non-delivery). Arrowheads may be used to indicate a buyer-to-seller relationship, a flow of goods, a flow of remuneration, a flow of feedback, or other directional relationships. Arrowheads may differ on each end of the same edge to indicate that, for example, where a first party fulfilled its obligations to a second party, and where the second party failed to fulfill its obligations to the first party (e.g., shipped and received goods, but did not pay; or paid for goods, but never shipped).

Two or more of the edge representations may be combined to include multiple indicia of characteristics of the relationship between the nodes. For example, a heavy dashed line may be used to indicate a strong relationship between two nodes, where the dashed line is meant to indicate that a transaction has not occurred for over thirty days. As another example, a line with a fill pattern may also include an arrowhead to indicate the flow of goods or services.

Other methods and graphical elements may be used to present meta-data or meta-information related to a node or an edge to a viewer. For example, an informational window may be programmed to appear when a node or edge is active (e.g., when a cursor is positioned over or around the node or edge in the screen). The informational window may be a tooltip window, a popup window, a child window, or other graphical user interface construct to provide graphical, textual, or other data to the viewer corresponding to information associated with the active node or edge. In another example, a user may activate a node or edge, such as by clicking on the node or edge of interest, which may then cause information to be displayed in the informational sidebar 602.

The user interface may include a legend to indicate to the viewing user what each graphical feature of an edge or node represents in the social graph.

### Example Machine Architecture

FIG. 9 is a block diagram of a machine in the example form of a computer system 900 within which a set of instructions for causing the machine to perform any one or more of the methodologies discussed herein may be executed, according to an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU) a graphics processing unit (GPU) or both), a main memory 904 and a static memory 906, which communicate with each other via a bus 908. The computer system 900 may farther include a video display unit 910 (e.g., a liquid crystal display (LCD) or a cathode ray tube (CRT)). The computer system 900 also includes an alphanumeric input device 912 (e.g., a keyboard), a user interface navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions (e.g., software 924) embodying any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media. The software 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, tangible media, such as solid-state memories, optical, and magnetic media.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
identifying a focal user, the focal user associated with a transaction;
determining a related user associated with the transaction, the related user having a buyer-seller relationship with the focal user; and
presenting, in a display, the focal user and the related user using a multi-node graph, the multi-node graph including a first node and a second node representing the focal user and the related user, respectively, and a first connector representing the buyer-seller relationship linking the first and second nodes, the first connector being presented with meta-data describing a characteristic of the buyer-seller relationship.

2. The method of claim 1, further comprising:
storing information associated with the transaction; and
searching the stored information to find the transaction that the related user is associated with.

3. The method of claim 1, wherein the meta-data includes a total monetary value of transactions associated with the buyer-seller relationship, an auction listing associated with the buyer-seller relationship, an item listing associated with the buyer-seller relationship, a date associated with the buyer-seller relationship, a date range associated with the buyer-seller relationship, or transaction data associated with the buyer-seller relationship.

4. The method of claim 1, wherein presenting the focal user further comprises presenting the first connector using a metric based on the buyer-seller relationship.

5. The method of claim 4, wherein presenting the first connector further comprises adjusting a characteristic of the first connector to represent a corresponding value of the metric.

6. The method of claim 5, wherein adjusting the characteristic of the first connector includes altering a width of the first connector, altering a weight of the first connector, altering a color of the first connector, altering a fill pattern of the first connector, including an arrowhead of the first connector, excluding an arrowhead of the first connector, or altering an arrowhead of the first connector.

7. The method of claim 5, wherein the metric includes a number of sales, a number of transactions, a reputation score, a positive rating, or a negative rating.

8. The method of claim 1, wherein presenting the focal user further comprises:
presenting the node representing the focal user using a geometric shape.

9. The method of claim 8, wherein the geometric shape is selected from the group of shapes comprising a circle, a square, a triangle, an octagon, an oval, and a star.

10. The method of claim 9, further comprising:
presenting the node representing the focal user using a particular geometric shape to correspond with a characteristic of the focal user.

11. The method of claim 8, wherein the geometric shape includes a border, the border including a width, color, or pattern used to indicate a characteristic of the node representing the focal user.

12. The method of claim 8, wherein the geometric shape includes an interior area, the interior area including a color, an image, or a pattern used to indicate a characteristic of the node representing the focal user.

13. The method of claim 1, further comprising:
arranging the nodes representing the focal user and the related user to indicate a geographical relationship.

14. The method of claim 1, further comprising:
arranging the nodes representing the focal user and the related user to indicate a geographical location.

15. The method of claim 1, further comprising:
presenting an auxiliary graphical element in association with the node representing the focal user.

16. The method of claim 15, wherein the auxiliary graphical element includes a flag to indicate a nationality of the focal user, a colored star to indicate a feedback rating of the focal user, or a miniature photograph to depict the focal user's identification.

17. The method of claim 1, wherein the focal user and the related user are users of an online commerce system.

18. The method of claim 17, wherein the focal user and the related user are users of an online auction system.

19. The method of claim 1, further comprising:
identifying a secondary related user, the secondary related user being related to the related user; and
presenting the related user and the secondary related user using a multi-node graph, the multi-node graph including the second node and a third node representing the related user and the secondary related user, respectively, and a second connector representing the buyer-seller relationship linking the second and third nodes, the second connector being presented with meta-data describing a characteristic of the buyer-seller relationship represented by the second connector.

20. The method of claim 1, further comprising:
determining a viewing user, the viewing user being a user viewing the presented multi-node graph;
determining whether the viewing user has a relationship with the focal user; and
presenting the focal user and the viewing user using the multi-node graph when the viewing user and the focal user have a relationship.

21. The method of claim 20, wherein the presenting the focal user and the viewing user further comprises:
calculating a degree of separation between the focal user and the viewing user; and
displaying the degree of separation using the multi-node graph.

22. The method of claim 20, wherein the presenting the focal user and the viewing user further comprises:
determining a path in the multi-node graph, the path connecting the focal user to the viewing user; and
displaying the path.

23. A system comprising:
a database server configured to provide a database of transactions to a plurality of users;
a data exporter to access the database of transactions;
a data processor to:
identify a focal user, the focal user associated with a transaction in the database of transactions; and
determine a related user associated with the transaction using the database of transactions, the related user having a buyer-seller relationship with the focal user; and
a data presenter to present the focal user and the related user using a multi-node graph, the multi-node graph including a first node and a second node representing the focal user and the related user, respectively, and a first connector representing the buyer-seller relationship linking the first and second nodes, the first connector being presented with meta-data describing a characteristic of the buyer-seller relationship.

24. The system of claim 23, wherein the meta-data includes a total monetary value of transactions associated with the buyer-seller relationship, an auction listing associated with the buyer-seller relationship, an item listing associated with the buyer-seller relationship, a date associated with the buyer-seller relationship, a date range associated with the buyer-seller relationship, or transaction data associated with the buyer-seller relationship.

25. The system of claim 23, wherein the data presenter is further configured to present the connector using a metric based on the buyer-seller relationship.

26. The system of claim 25, wherein the data presenter is further configured to adjust a characteristic of the connector to represent a corresponding value of the metric.

27. The system of claim 26, wherein the data presenter is further configured to adjust the characteristic of the connector by altering a width of the connector, altering a weight of the connector, altering a color of the connector, altering a fill pattern of the connector, including an arrowhead of the connector, excluding an arrowhead of the connector, or altering an arrowhead of the connector.

28. The system of claim 26, wherein the metric includes a number of sales, a number of transactions, a reputation score, a positive rating, or a negative rating.

29. The system of claim 23, wherein the data presenter is further configured to present the node representing the focal user using a geometric shape.

30. The system of claim 29, wherein the geometric shape is selected from the group of shapes comprising a circle, a square, a triangle, an octagon, an oval, and a star.

31. The system of claim 30, the data presenter is further configured to present the node representing the focal user using a particular geometric shape to correspond with a characteristic of the focal user.

32. The system of claim 29, wherein the geometric shape includes a border, the border including a width, color, or pattern used to indicate a characteristic of the node representing the focal user.

33. The system of claim 29, wherein the geometric shape includes an interior area, the interior area including a color, an image, or a pattern used to indicate a characteristic of the node representing the focal user.

34. The system of claim 23, the data presenter is further configured to arrange the nodes representing the focal user and the related user to indicate a geographical relationship.

35. The system of claim 34, the data presenter is further configured to arrange the nodes representing the focal user and the related user to indicate a geographical location.

36. The system of claim 34, the data presenter is further configured to present an auxiliary graphical element in association with the node representing the focal user.

37. The system of claim 36, wherein the auxiliary graphical element includes a flag to indicate a nationality of the focal user, a colored star to indicate a feedback rating of the focal user, or a miniature photograph to depict the focal user's identification.

38. The system of claim 34, wherein the focal user and the related user are users of an online commerce system.

39. The system of claim 38, wherein the focal user and the related user are users of an online auction system.

40. A computer readable medium including instructions that, when executed on a computer, cause the computer to:
identify a focal user, the focal user associated with a transaction;
determine a related user associated with the transaction, the related user having a buyer-seller relationship with the focal user; and
present the focal user and the related user using a multi-node graph, the multi-node graph including a first node and a second node representing the focal user and the related user, respectively, and a first connector representing the buyer-seller relationship linking the first and second nodes, the first connector being presented with meta-data describing a characteristic of the buyer-seller relationship.
